(19) United States
(12) Patent Application Publication
(10) Pub. No.: US 2023/0252230 A1
(43) Pub. Date: Aug. 10, 2023

(54) SYSTEMS AND PROCESSES FOR TEXT EXTRACTION AND ANALYSIS

(71) Applicant: The Rocket Science Group LLC, Atlanta, GA (US)

(72) Inventor: Michael Patzer, Atlanta, GA (US)

(21) Appl. No.: 17/667,315

(22) Filed: Feb. 8, 2022

(51) Int. Cl. G06F 40/174; G06F 16/34; G06T 7/70; G06V 30/22; G06F 3/0484; G06V 30/14; G06V 30/19

(52) U.S. Cl. CPC G06F 40/174; G06F 16/34; G06T 7/70; G06V 30/22; G06F 3/0484; G06V 30/14; G06V 30/19; G06T 2207/30176

(57) ABSTRACT

A system can include a data store, including a subscriber list, and a computing device in communication therewith. The computing device can perform optical character recognition of an image to identify text portions, each text portion including position data and a subset of text portions including handwritten data. The computing device can associate each text portion with a respective column of a plurality of columns and a respective row of a plurality of rows based on the position data. The computing device can analyze individual ones of text portions associated with a particular column to determine a particular data type corresponding to the particular column. The computing device can generate a respective entry to the subscriber list for individual ones of a subset of the plurality of rows with individual ones of the text portions from the particular column being stored in a field associated with the particular data type.

### TECHNICAL FIELD

The present systems and processes can relate to analysis and classification of handwritten content.

### BACKGROUND

At events, event hosts commonly have sign-up sheets to collect handwritten information from attendees of the event, such as name, address, and email, among others. The handwritten sign-up sheets can be converted to optical character recognition (OCR) data by an OCR process; however, previous approaches for leveraging the translated handwriting typically require the OCR data to be transcribed by a human into a normalized format (e.g., a format that preserves handwriting format and corrects for handwriting errors). While such processes for interpreting handwritten documents may be trivial for humans, the variability of handwriting style and text alignment may result in OCR data that is difficult for a computer to accurately process and leverage. Previous computer-implemented solutions for processing OCR data typically focus on recognizing single words or phrases for the purposes of translation (for example, Google Translate). The previous solutions may be agnostic as to the particular type of data associated with the words and phrases and, thus, the solutions may be unable to leverage the recognized data for more complex purposes, such as generating subscriber lists and transmitting targeted communications.

Therefore, there is a long-felt but unresolved need for a system or process that precisely and accurately generates and classifies OCR data and performs complex actions based thereon.

### BRIEF SUMMARY OF THE DISCLOSURE

Briefly described, and according to one embodiment, aspects of the present disclosure can relate to systems and processes for recognizing and classifying text data. In particular embodiments, the present systems and processes classify handwritten and/or other types of text into one or more data types and perform various actions based on the data, such as, for example, generating subscriber lists and initiating targeted communication campaigns.

In various embodiments, the present technology provides substantially automated systems and processes for analyzing OCR translations of text sources (for example, handwritten sign-up sheets) and generating records based thereon. The present systems and processes can support additional functions, such as generating columns and rows from the OCR data, generating user records, identifying links between participants, identifying categories of data based on labels and values of data (e.g., if 75% of values match a surname list, the category may be assigned as surname), and correcting OCR errors based on expected format for the category (e.g., changing “,com” to “.com” for an email address).

According to one embodiment, the present system receives image data (e.g., from a computing device, such as a smartphone) that includes, for example, a photo of a sign-up sheet containing handwritten personal information and, potentially, typed/printed information (e.g., a table in which the handwritten text is printed). The system can process the image data to confirm proper image alignment and to detect boundaries of one or more documents shown therein. The system can analyze the image data via one or more OCR algorithms or other techniques to generate OCR data, such as an unordered array of text elements.

The system can perform various analyses and apply one or more algorithms to evaluate and classify the OCR data. The system can sort the OCR data into a coordinate space (e.g., a data table) in an arrangement mirroring the arrangement of the image data on the one or more documents. For example, the system sorts OCR data from a collimated sign-up sheet into a data table in a similar collimated structure. The system can sort the OCR data by identifying coherent text strings (e.g., words) and sorting the words based on their Y-origin within the image data. The system can group the words into rows using a grouping threshold and/or algorithm. In one example, each word includes a frame, which defines the size and position of a rectangle that contains the word relative to the encompassing coordinate space. In this example, the frame includes X—and Y-coordinates that define the origin of the rectangle, as well as a width and height of the rectangle. The system can compute a grouping threshold by calculating an average height of each word in the coordinate space and defining the grouping threshold by selecting the lesser of a) half the overall average height (e.g., a mean of means) or b) a shortest average line height minus one. In applying the grouping threshold, the system can compare the middle Y-origin value of adjacent frames (e.g., words) to the grouping threshold and, in response to each half-height value meeting the grouping threshold, determine that the adjacent frames are in the same row.

After sorting, the system can analyze the OCR data to classify the contents of each column and frame thereof. Classifications for each column and frame can be represented as frame labels and/or stored in metadata. The system can perform one or more pre-processing steps, for example, to remove unlikely characters (e.g., scribbles and other marks) and/or to impute partial characters (e.g., dotting an “i,” etc.). The system can automatically detect column headers, for example, by comparing frame elements of one or more rows (in particular, a first row) to known header terms (e.g., “first,” “last,” “email,” “address,” etc.). In response to detecting column headers, the system can classify frames arranged within the same column according to the header (e.g., frames sharing a column with an “email” header frame may be classified as “email” frames). As an alternative or concurrent process to classification via headers, the system can analyze each column in the coordinate space to generate a classification for the same. The system can perform the analysis by applying various rules, such as determining that a character length meets a particular threshold or that a frame contains a special character, common substring, valid personal name, etc. As one example, the system determines that frame text corresponds to a proper noun and does not match any first name in a dataset of common first names, and, therefore, the frame text corresponds to a last name. The system can classify each frame in a column and generate an overall column classification based on identifying a particular frame classification most prevalent in the column (e.g., above a predetermined threshold).

Following classification of each column and frame in the coordinate space, the system can generate a “contact” or “user record” for each row. As an example, for a particular row, a contact includes a first name, a last name, and an email address. The system can transmit the contacts to a computing device for display in an interface rendered thereon. The computing device can receive, via the interface, user inputs to edit one or more items. The system can receive and store the edits to the items for use in improving subsequent processes. For example, the system analyzes historical edits to identify common corrections and implement the same in a pre-processing step. The system can perform one or more actions automatically or in response to interface inputs. The one or more actions can include, for example, adding one or more contacts to a subscriber list for a targeted email or mailer campaign, generating digital profiles for one or more contacts, transmitting an electronic communication to one or more contacts, and determining if one or more contacts are included in other contact lists.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an exemplary handwriting analysis system according to one embodiment of the present disclosure.

FIG. 2 shows an exemplary handwriting classification sequence according to one embodiment of the present disclosure.

FIG. 3 is a flowchart of an exemplary handwriting analysis process according to one embodiment of the present disclosure.

FIG. 4 is a flowchart of an exemplary association generation process according to one embodiment of the present disclosure.

FIG. 5 shows exemplary user interfaces of a handwriting analysis system according to one embodiment of the present disclosure.

FIG. 6 shows exemplary user interfaces of a handwriting analysis system according to one embodiment of the present disclosure.

FIG. 7 shows exemplary user interfaces of a handwriting analysis system according to one embodiment of the present disclosure.

FIG. 8 shows exemplary user interfaces of a handwriting analysis system according to one embodiment of the present disclosure.

FIG. 9 shows exemplary user interfaces of a handwriting analysis system according to one embodiment of the present disclosure.

FIG. 10 shows exemplary user interfaces of a handwriting analysis system according to one embodiment of the present disclosure.

FIG. 11 shows exemplary user interfaces of a handwriting analysis system according to one embodiment of the present disclosure.

FIG. 12 shows exemplary user interfaces of a handwriting analysis system according to one embodiment of the present disclosure.

FIG. 13 shows exemplary user interfaces of a handwriting analysis system according to one embodiment of the present disclosure.

FIG. 14 shows exemplary user interfaces of a handwriting analysis system according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For purposes of illustrating and describing exemplary aspects of the disclosed technology, the following description is presented in the context of analyzing and classifying handwritten text. It will be understood and appreciated that the described systems and processes can be used to evaluate any text including but not limited to handwritten text, typed text, printed text, and scanned text. It will also be understood that the present systems and processes may be applied to any alphabet, including non-latin alphabets, such as, for example, Cyrillic, Arabic, Hebrew, Korean, or Greek alphabets.

### Overview

Aspects of the present disclosure can relate to text recognition, classification, data correction, data extraction, and data management.

At a high level, the present technology relates to systems and processes for generating and analyzing optical character recognition (OCR) data, predicting a format and layout of data into one or more categories to which OCR data pertains, and classifying the OCR data accordingly. In some embodiments, OCR data can refer to machine-encoded text from conversion of images of typed, handwritten, or printed text.

### EXEMPLARY EMBODIMENTS

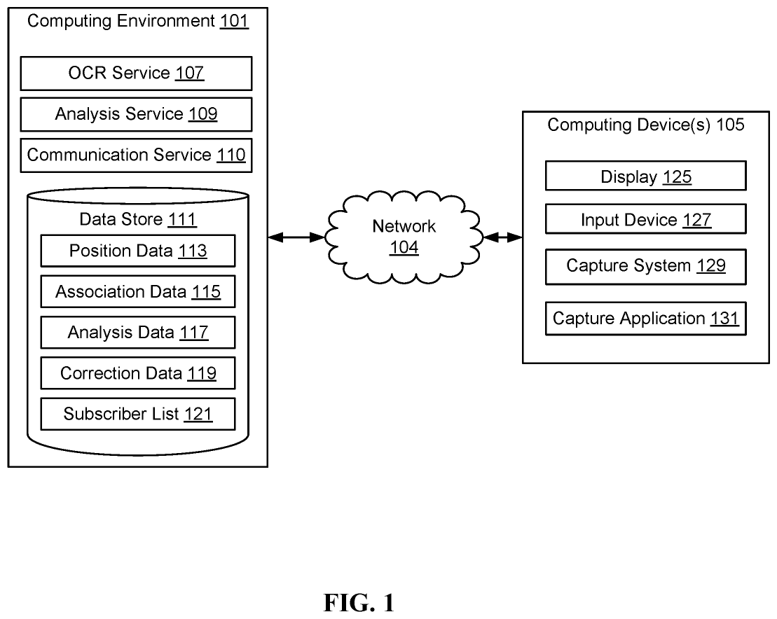

Referring now to the figures, for the purposes of example and explanation of the fundamental processes and components of the disclosed systems and processes, reference is made to FIG. 1, which illustrates an exemplary, handwriting analysis system 100 (e.g., also referred to as the “system 100”). As will be understood and appreciated, the system 100 shown in FIG. 1 represents merely one approach or embodiment of the present system, and other aspects are used according to various embodiments of the present system.

In various embodiments, the system 100 is configured to perform one or more processes for analyzing, correcting, and normalizing image data that includes handwritten and/or printed text among other potential information. The system 100 can capture a document image that includes handwritten text. The system 100 can process the image using optical character recognition (OCR) to generate OCR data by identifying handwritten data within the image and generating one or more text portions based on the OCR data and the handwritten data. Once processed, the system 100 can analyze the OCR data and the handwritten data of each text portion to generate subscriber records.

The system 100 can analyze the OCR data and the handwritten data to associate each text portion with a particular type of data. In one example, the system 100 determines that a first set of text portions are aligned into a column and include first names, and, in response, the system 100 associates the first set of text portions (e.g., and/or a column including the same) with a “first name” data type. Continuing the example, the system 100 determines that a second set of the text portions is aligned into a second column and associated with a “last name” data type and that a third set of the text portions is aligned into a third column and is associated with an “email address” data type. The system 100 can perform error correction following data type association by applying rules and policies that are specific to particular types of data, such as, for example, email formatting rules, phone number formatting rules, or physical address policies.

The system 100 can perform actions based on the row, column, and data associations of the handwritten data, such as, for example, generating an entry for each row of text portions and generating a subscriber list based on the entries. The system 100 can leverage column associations to group text portions of the same data type into the same field (for example, text portions with the same data type association are grouped into columns). The system 100 can store the subscriber list and/or each entry in a data store and can transmit the subscriber list to a computing device for presentation to a user. The computing device can generate and store in memory a contact for each entry. The system 100 can receive user input defining one or more corrections to the subscriber list and can apply corrections to one or more entries of the subscriber list based on the user input. The system 100 can initiate a targeted campaign by transmitting electronic communications to each entry of the corrected subscriber list.

The system 100 may include, but is not limited to, a computing environment 101 and one or more computing devices 105 that communicate over a network 104. The network 104 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

According to one embodiment, the computing environment 101 includes, but is not limited to, an optical character recognition (OCR) service 107, an analysis service 109, and a data store 111. The elements of the computing environment 101 can be provided via one or more computing devices that may be arranged, for example, in one or more server banks or computer banks or other arrangements. Such computing devices can be located in a single installation or may be distributed among many different geographical locations. For example, the computing environment 101 can include a plurality of computing devices that together may include a hosted computing resource, a grid computing resource, and/or any other distributed computing arrangement. In some cases, the computing environment 101 can correspond to an elastic computing resource where the allotted capacity of processing, network, storage, or other computing-related resources may vary over time.

The OCR service 107 can refer to a system, program, or module that performs optical character recognition on an image to identify and group text and other characters in the image. The OCR service 107 can receive an image as an input. As an output, the OCR service 107 can generate a plurality of text portions (e.g., or data defining the location thereof in the image). In some embodiments, the OCR service 107 is an external element that may be called by the computing environment 101 via the network 104 to execute OCR functions. In one example, the OCR service 107 is a remote service (e.g., such as Google's Cloud Vision API) that receives images from the computing environment 101 and generates data defining the location of text portions in the images (e.g., referred to as position data 113). In another example, the OCR service 107 is a remote library of computing functions and the computing environment 101 calls one or more computing functions of the remote library to perform OCR on images and generate position data 113. The OCR service 107 can include one or more machine learning models for recognizing various types of text (e.g., handwritten text, printed text, etc.). The OCR service 107 can train machine learning models using training datasets and validation datasets that include, for example, handwriting images and/or manual corrections to historical handwriting recognition output.

The analysis service 109 can perform various analyses, transformations, and classifications of text portions described herein. The analysis service 109 can evaluate outputs of the OCR service 107 and inputs from the computing device 105 to perform text portion grouping, data type association, and error correction. The analysis service 109 can apply rules, policies, and algorithms to OCR data including one or more text portions (e.g., or data/metadata associated therewith) to modify or correct the OCR data. The analysis service 109 can modify or correct the OCR data by grouping text portions into one or more rows and one or more columns, correcting errors in the text portions and associated text portions. The analysis service 109 can correct the errors based on conformity with one or more data types. The analysis service 109 can determine associations between text portions and one or more data types including, but not limited to, first names, middle names, last names, email addresses, phone numbers, identifiers, nicknames, usernames, physical addresses, titles, company names, team affiliations, option selections, and size or other dimensional selections. The analysis service 109 can generate, train, and execute machine learning models for performing various functions described herein.

The communication service 110 performs various actions to organize and communicate output of the OCR service 107 and the analysis service 109. The communication service 110 can generate and transmit subscriber lists 121, searchable reports, and electronic communications to one or more computing devices 105. In one example, the analysis service 109 generates an output including one or more names and corresponding contact information. In the same example, the communication service 110 generates a subscriber list 121 based on the output. The communication service 110 can transmit the subscriber list 121 to a capture application 131 of a computing device 105 for presentation to a user. In some embodiments, the communication service 110 includes one or more networking addresses (e.g., websites, portals, etc.) at which subscriber lists 121, searchable reports, electronic communications and/or other outputs of the system 100 may be accessed.

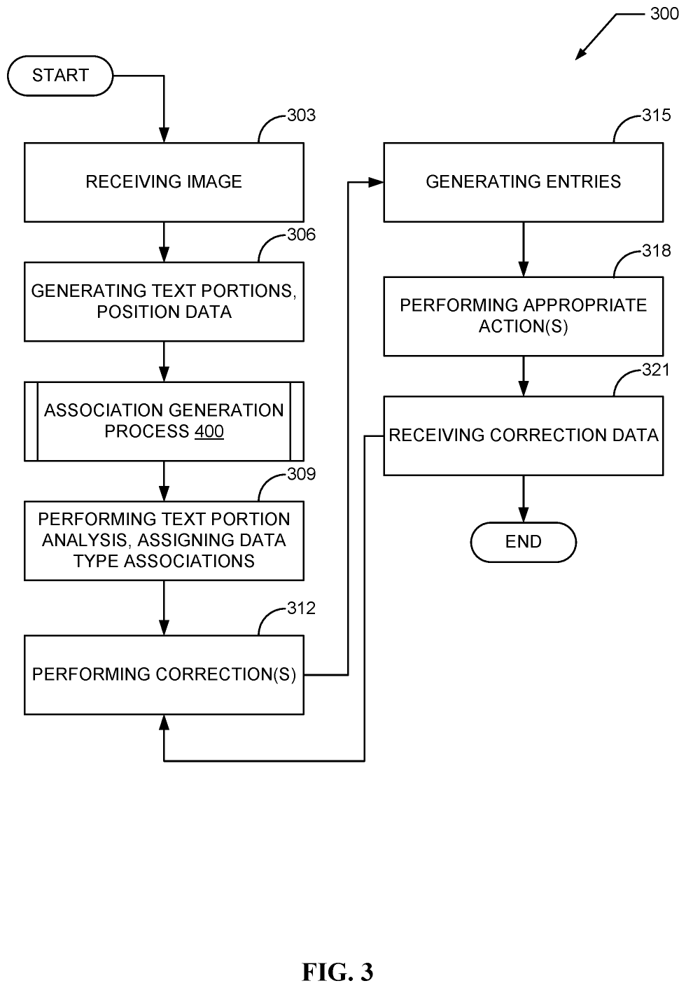

The communication service 110 can receive and process one or more inputs from the computing device(s) 105 to initiate, modify, or otherwise control processes described herein. For example, the communication service 110 receives a document image from a computing device 105 (e.g., via the capture application 131) and automatically initiates a handwriting analysis process 300 (FIG. 3) to detect and classify text portions in the document image. The communication service 110 can command the OCR service 107 and/or the analysis service 109 to perform or adjust various functions based on input from the computing device 105. For example, the communication service 110 can receive user inputs that correct a data type association for a text portion. Continuing the example, the communication service 110 can store the user inputs in correction data 119. The communication service 110 can cause the analysis service 109 to adjust subsequent data type association processes to correct for the erroneous association. As an example, the system 100 can retrain or tune a machine learning or artificial intelligence model based on the erroneous association to improve accuracy going forward.

The data store 111 can store various data that is accessible to the various elements of the computing environment 101. In some embodiments, data (or a subset of data) stored in the data store 111 is accessible to the computing device 105 and one or more external systems (e.g., on a secured and/or permissioned basis). Data stored at the data store 111 can include, but is not limited to, position data 113, association data 115, analysis data 117, correction data 119, and subscriber lists 121. The data store 111 can be representative of a plurality of data stores 111 as can be appreciated.

The position data 113 can include information that defines an arrangement or location of text within an image (e.g., or within a document represented in the image). The position data 113 can include coordinates and dimensions that define boxes for representing detected text in an image. For example, the position data 113 includes coordinates and dimensions generated by the OCR service 107 based on an OCR process applied to an image of a business card. The position data 113 includes position thresholds, boundaries, and other metrics determined by the OCR service 107 or the analysis service 109. For example, the position data 113 includes an average box height for OCR boxes generated from a document image, the average box height having been computed by the analysis service 109 based on coordinates and dimensions of text detected in the document image. In the same example, the position data 113 includes a row-grouping threshold computed by the analysis service 109 based on the average box height (e.g., or another metric or metric combination, such as the minimum between the minimum box height in the document image and half of the average box height).

The association data 115 can refer to data that defines groupings, categorizations, or classifications of text portions, headers, columns, or rows. The association data 115 can include information for indicating that a particular text portion of a document image is associated with a particular row and a particular column in the document image. For example, the association data 115 includes a mapping of text portions across each row and column of a document image. The association data 115 can include information indicating that a particular text portion of a document image is associated with a particular type of data (e.g., first name, last name, phone number, email, address, etc.). For example, the association data 115 includes a table that categorizes each text portion of a document image into one or more data types.

The analysis data 117 can refer to rules, policies, and models that may be applied by the analysis service 109 to perform analyses described herein. The analysis data 117 can include rules for identifying particular types of data. For example, the analysis data 117 includes a sequence of rules that the analysis service 109 applies to a text portion (e.g., and/or rows or columns associated therewith) to determine if the text portion is associated with a “first name” data type. In this example, the rules can include a dataset of characters associated with first names, a dataset of common first names, and a dataset of header labels that are typically associated with first names. In another example, the analysis data 117 includes a sequence of rules that the analysis service 109 applies to position data 113 of a text portion to determine an association between the text portion and a particular row. In this example, the rules can include an algorithm or other expression that is executed by the analysis service 109 to compute a row-grouping threshold for determining row association.

The analysis data 117 can include data associated with machine learning and other modeling processes described herein. Non-limiting examples of analysis data 117 include, but are not limited to, machine learning models, parameters, weight values, input and output datasets (for example, historical handwriting images and historical associations derived therefrom), training datasets, validation sets, configuration properties, and other settings. The analysis data 117 can include training datasets that include correction data 119 paired with historical handwriting images that demonstrate or do note demonstrate a particular error defined in the correction data 119 (for example, data type classification errors or position grouping errors). The analysis service 109 can use the training datasets to train one or more handwriting text recognition machine learning models such that the errors defined by the correction data 119 are not repeated in subsequent analyses of handwriting images (e.g., thereby improving accuracy and precision of the system 100).

The correction data 119 can refer to data that defines errors and error corrections received from computing devices 105 (e.g., based on manual user review and input) or generated by the analysis service 109. The correction data 119 can include historical corrections initiated by a user to change a data type classification of a text portion from a first data type (for example, first name) to a second data type (for example, middle name, last name, or address). The correction data 119 can include historical corrections initiated by a user to change a row or column association of a text portion to another row or column. The correction data 119 can include analysis- or user-derived corrections to spelling errors, punctuation errors, row- or column-grouping errors, or OCR-based errors (e.g., text recognition errors and position recognition errors). The analysis service 109 can generate training datasets and validation training datasets based on correction data 119 to train one or more machine learning models to perform error corrections (e.g., or avoid particular errors) represented thereby. The analysis service 109 can generate rules and policies based on correction data 119 to improve text portion association and grouping processes described herein. For example, the analysis service 109 determines that a particular type of manual error correction was performed by a large number of users (e.g., or performed by a quantity of users above a predetermined threshold). In the same example, the analysis service 109 evaluates iterations of the particular type of manual correction to generate a new rule that may be applied in subsequent analyses to avoid errors that resulted in the particular type of manual correction.

The subscriber list 121 refers to data that defines one or more individuals, groups, or other entities. The subscriber list 121 can include one or more of, but is not limited to, names (e.g., first names, middle names, surnames, prefixes, etc.), nicknames, entity names (e.g., company names, group names, etc.), identifiers (for example, driver's license number, social security number, public wallet identification, or student identification number), usernames, titles, phone numbers, physical addresses, email addresses, biometric information (for example, a fingerprint, palm print, facial image, voice sample, or iris scan), payment processing information (for example, card number, expiration date, cvv, and zipcode), images (for example, a user profile image or a digital avatar), videos, three-dimensional models, In one example a subscriber list 121 includes a set of identifiers and contact information for individuals that filled out an attendance sheet or other sign-up form during an in-person event. In another example, a subscriber list 121 includes a set of company names, full names, titles, emails, and phone numbers derived from a plurality of business cards.

The system 100 can perform various actions related to entries of the subscriber list 121 with communications for services, products, activities, memberships, or other offers. For example, the communication service 110 executes a targeted campaign by transmitting emails to an email address associated with each entry of a subscriber list 121. In another example, the communication service 110 generates a contact file (e.g., Vcard files, .txt files, etc.) for each entry of a subscriber list 121 and transmits the contact files to the capture application 131. In the same example, the capture application 131 causes the computing device 105 to generate and store a contact for each contact file.

The computing device 105 can be any network-capable device including, but not limited to, smartphones, computers, tablets, smart accessories, such as a smart watch, key fobs, and other external devices. The computing device 105 can include a processor and memory. The computing device 105 can include a display 125 on which various user interfaces can be rendered. The computing device 105 can include an input device 127 for providing inputs, such as requests and commands, to the computing device 105. The input devices 127 can include a keyboard, mouse, pointer, touch screen, speaker for voice commands, camera or light sensing device to reach motions or gestures, or other input devices. The computing device can include a capture system 129 for capturing images, such as, for example, images of a sign-up sheet or other document including handwritten information. The capture system 129 can include one or more cameras or other suitable elements for scanning and capturing images.

The computing device can include a capture application 131 that configures, monitors, and controls various functions of the system 100. The capture application 131 can correspond to a web browser and a web page, a mobile app, a native application, a service, or other software that can be executed on the computing device 105. The capture application 131 can display information associated with processes of the system 100 and/or data stored thereby. In one example, the capture application 131 causes the computing device 105 to render a subscriber list 121 generated by the computing environment 101. In another example, the capture application 131 receives text portions and data types thereof generated by the analysis service 109 (e.g., first name, last name, email address, phone number). In the same example, the capture application 131 causes the computing device 105 to generate and store in memory a new contact entry based on the text portions and associated data types.

In another example, the capture application 131 causes the computing device 105 to render a categorized table of information extracted from a sign-up sheet image. In the same example, the capture application 131 renders, for each table entry, a confidence level that represents a level of confidence in the accuracy of the corresponding categorization. In this example, the capture application 131 can render the levels of confidence based on a coloring scheme (e.g., red for a lowest level of confidence, yellow for a middle level of confidence, and green for a higher or highest level of confidence), thereby providing a user with an indication of which table entries may most require manual review and/or revision.

The capture application 131 can process the inputs and transmit commands, requests. The capture application 131 can process messages from and transmit responses to the computing environment 101 or additional computing devices 105. For example, via the input device 127, the capture application 131 receives a user's corrections to an entry of a subscriber list 121 generated by the computing environment 101. In the same example, the capture application 131 transmits the corrections to the computing environment 101 for storage as correction data 119 that may be used to improve accuracy and precision of subsequent handwriting analysis processes. In another example, via the capture system 129, the capture application 131 receives an image of a sign-up sheet including handwritten text and transmits the image to the computing environment 101. In this example, the transmission of the image to the computing environment 101 can define a command that instructs the computing environment 101 to analyze and categorize the handwritten text and generate a profile (e.g., a user profile, a contact entry, etc.) for each entry of the sign-up sheet.

The capture application 131 can capture an image of a document. The document can include one or more handwritten portion. The handwritten portions can be arranged in columns and rows. In some embodiments, the document includes printed portions. The printed portions can include labels, lines corresponding to the tables and rows, header and/or footer information, and other details. The header or footer information can include timing information (e.g., a date and time of an event), entity information (e.g., a name of a company or person, contact information for the company or person, and other details for a company or person that may be hosting an event), and other information. The capture application 131 can transmit the captured image to the computing environment 101. The OCR service 107 can perform optical character recognition on the image including the handwritten portion to generate data for the image. The data for the image can include one or more text portions. The text portions can each include metadata including position data, text data. In some embodiments, the text portions each correspond to a data structure that includes a particular point of the text portion (e.g., an upper left corner of an identified image for the text portion), a width of the text portion, a length of the text portion, and a text identified in the text portion. In some embodiments, the OCR service 107 can perform the optical character recognition on the image and identify the text portion by generating a call to one or more of a library or service.

The OCR service 107 can identify a local region associated with a current user account. The OCR service 107 can determine one or more languages and/or one or more character sets (e.g., Latin characters, Greek characters, Chinese characters, Japanese characters, etc.) associated with the local region. The OCR service 107 can determine one or more languages and/or one or more character sets associated with a profile of the user. The OCR service 107 can recognize the text portion based on the one or more languages and/or character sets associated with the user. In some embodiments, the OCR service 107 can recognize a language of a first text portion and use the identified language to recognize text in other text portions. In another embodiment, the OCR service 107 can recognize one or more character sets based on one or more characters identified in the image. The OCR service 107 can utilize the language and/or character set to identify and recognize text in text portions in the image. In one embodiment, the OCR service 107 can iterate through each text portion, and during each iteration, identify one or more respective languages and/or character sets for the text portion. The OCR service 107 can utilize one or more specific libraries/functions/code segments for each identified language and/or character set to recognize the respective portion. In some embodiments, the OCR service 107 can identify two or more languages and/or character sets in a particular text portion, and generate two or more new text portions with each text portion including only one language and/or character set. In this embodiment, the OCR service 107 can recognize the text from each language and/or character set in each new text portion using a different library. In some embodiments, the OCR service 107 can generate a combined text portion after identifying the languages and/or character sets from different languages and/or character sets or leave the text portions as separate for further processing as described herein.

The analysis service 109 can analyze the text portion data structure to determine an association for each of the text portions with a row and column of a table. As an example, the analysis service 109 can use position data (e.g., the particular point, width, and length of the text portion) to determine that a first text portion is in a first row and a first column, a second text portion is in a second row and the first column, a third text portion is in the first row in a second column, and a fourth text portion is in the second row and the second column using the position data. The analysis service 109 can determine whether a header or footer corresponds to a particular column. The analysis service 109 can identify the type of data in the column based on the header or footer.

The analysis service 109 can determine a vertical position threshold for each row based on the position data from the text portions. For example, the analysis service 109 can compute an average vertical height of the text portions for use as the vertical position threshold. In another example, the analysis service 109 can determine a minimum vertical height of the text portions and defines the vertical position threshold based on the minimum vertical height (e.g., plus or minus a predetermined constant). The analysis service 109 can perform row assignment by determining a vertical midpoint for each text portion. The analysis service can define the vertical position threshold as a box (e.g., with height equal to the vertical position threshold) centered about the vertical midpoint of a first text portion (for example, a left, uppermost text portion). The analysis service 109 can determine a subset of text portions with vertical midpoints that fall within the vertical position threshold box. The analysis service 109 can assign the first text portion and the subset to a row. The analysis service 109 can iterate through the remaining non-row-assigned text portions to generate additional row assignments. The analysis service 109 can recalibrate and update the vertical position threshold following or during the creation of a row.

In an exemplary scenario, the analysis service 109 determines a first vertical position threshold for a row based on the respective position data of a first text portion of a plurality of text portions. The analysis service determines a second text portion meets the vertical position threshold based on the respective position data of the second text portion. The analysis service 109 determines an updated vertical position threshold for the row (e.g., based on the respective position data for both of the first text portion and the second text portion) and the analysis service 109 analyzes additional text portions using the updated vertical position threshold. The analysis service 109 iterates through a remaining subset of the plurality of text portions and determines that a current iteration text portion meets the updated vertical position threshold based on the respective position data of the current iteration text portion. The analysis service 109 assigns the current iteration text portion to a set of text portions in the row (e.g., the set of text portions including the first text portion and the second text portion). The analysis service 109 recalibrates and updates the updated vertical position thresholds for the row further based on the respective position data for the current iteration text portion.

The analysis service 109 can analyze the text data for portions assigned to each respective column to determine a type of data associated with the respective column. The type of data can include, among others, a first name, a middle name, a last name, an address, a company name, and a title. As an example, the analysis service 109 can determine that a subset of the text portions assigned to a particular column include text identified as a first name. As another example, the analysis service 109 can determine that a subset of the text portions assigned to a particular column include formatting that corresponds to an email address. The analysis service 109 can generate a subscriber entry in data store 111 for each row in the table using text portions that are within the row to populate the data.

The analysis service 109 can analyze the text portions to identify one or more text corrections. In some embodiments, the analysis service 109 determines recommended corrections, and the capture application 131 presents the recommendations to a user for the user to input whether or not to make the correction. The analysis service 109 can identify the text corrections based on the type of data assigned to a column that the text portion is assigned to. As an example, the analysis service 109 can determine the text portion is assigned to a first name column and identify an “@” symbol as being a potential text correction. In this example, the analysis service 109 can recommend that the symbol be changed or change “@” to “a” in the text portion. In another example, the analysis service 109 can search a database of known addresses to determine a correction to a text portion in an address column. In this example, the analysis service 109 can match “555 Gate Street, New York, N.Y. 10000” to “555 Gate Street, Manhattan, NY 10001,” and perform the correction or recommend the text correction. The analysis service 109 can store data regarding the performed text corrections, recommended text corrections, and identified text corrections in correction data 119.

In one embodiment, the analysis service 109 can identify characters (e.g., letters, numbers, symbols, and/or punctuation) in a text portion in a column identified as an email field. The analysis service 109 can determine the characters in the email address that does not fit a format of email addresses. The analysis service 109 can change the characters to fit the format of the email address. In some embodiments, the analysis service 109 and/or the capture application 131 can validate the email field based on a count of characters in the email field (e.g., by comparing the count of characters in the email field to an allowed length of an email address). In some embodiments, the capture application 131 can render a user interface including one or more text portions arranged in rows and columns. The capture application 131 can receive edits to move one or more text portions to a different column or row. The capture application 131 can receive edits or corrections to text identified in the text portions via the user interface. The corrections can be stored in correction data 119. The system can use the corrections to identify one or more additional corrections (e.g., similar or equivalent corrections) in the text portions. In some embodiments, the correction data 119 can be used to train a machine learning model to improve automated text corrections for subsequent documents.

While reference is made herein to rows and columns of tables, it can be appreciated that the orientation of a table can vary. In some embodiments, a column may be oriented from the top of a document to the bottom of the document, while a row is oriented from the left of the document to the right of the document. In other embodiments, a column may be oriented from the left of a document to the right of the document, while a row is oriented from the top of the document to the bottom of the document. It can be appreciated that the terms “column” and “row” are intended to encompass various orientations.

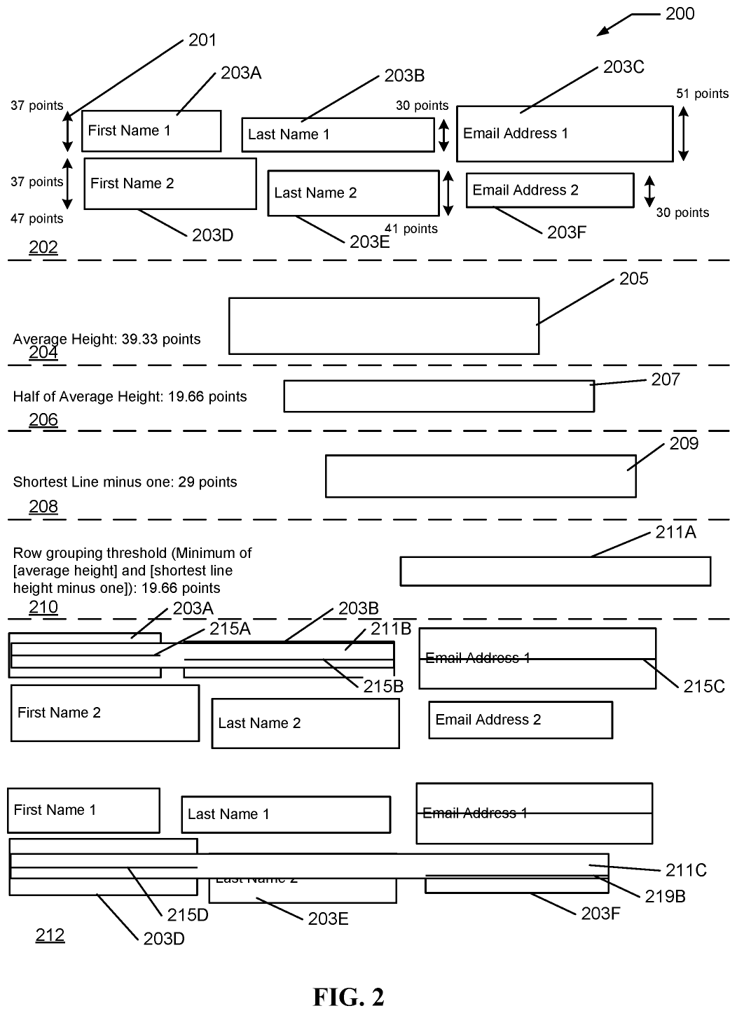

FIG. 2 shows an exemplary handwriting classification sequence or process 200. In various embodiments, the system 100 performs the sequence 200 to associate text portions extracted from a document image with particular rows of the document image. For example, the analysis service 109 performs the process 200 to compute row-grouping thresholds based on position data 113 and generate a row association for each of a plurality of text portions based on the row-grouping thresholds. As further described below, the system 100 can compute the row-grouping threshold based on text portion heights and analyses of text portion position along a vertical axis (e.g., a Y-axis). The system 100 can compute a column-grouping threshold (e.g., in a manner similar to the sequence 200) based on text portion widths and analyses of text portion position along a horizontal axis (e.g., an X-axis).

At step 202, the sequence 200 includes computing a height 201 of each text portions 203A-F. The computing environment 101 can store the height 201 of each text portions 203A-F as position data 213. In at least one embodiment, the height 201 defines a dimension of a text portion in the Y-direction. In one example, in addition to text portions the OCR service 107 outputs text portion metadata including the height 201 of each text portion, which may be stored as position data 113. In this example, the analysis service 109 obtains the height 201 of each text portion 203A-F by retrieving the associated position data 113. In another example, the analysis service 109 processes the text portions 203A-F (e.g., or a file including the same) and computes the height 201 based on coordinates that define the boundaries of each text portion. In some embodiments, the analysis service 109 determines height 201 based on pixel data associated with each text portion 203A-F. For example, the analysis service 109 determines that the text portion 203A demonstrates a pixel height of about 37 pixels and the analysis service 109 determines the height of the text portion 203A to be 37 points.

At step 204, the sequence 200 includes determining an average text portion height 205. The average text portion height 205 can refer to a mean value of the heights of each of the text portions 203A-F. The analysis service 109 can compute the average text portion height 205 by computing a mean, median, or mode of the heights 201 of the text portions 203A-F (e.g., or a subset thereof). In some embodiments, the OCR service 107 computes the average text portion height 205 and attaches the value to output text portions as metadata, which may be stored as position data 113. The analysis service 109 can obtain the average text portion height 205 by retrieving the value from position data 113.

At step 206, the sequence 200 includes computing a grouping threshold candidate 207 based on the average text portion height 205. The analysis service 109 can compute the grouping threshold candidate 207 by halving the average text portion height 205.

At step 208, the sequence 200 includes computing a second grouping threshold candidate 209. The analysis service 109 can compute the grouping threshold candidate 209 by determining the minimum height 201 of the text portions 203A-F and, in some embodiments, applying an adjustment to the minimum height. For example, the analysis service 109 determines that the text portions 203A-F include a minimum height 201 of about 30 points and the analysis service 109 applies an adjustment by subtracting 1 unit from the minimum height to compute a grouping threshold 209 of about 29 points. The adjustment to the minimum height can ensure that the grouping threshold 209 is inclusive of all text portions 203A-F (e.g., including the text portion 203A-F that demonstrates the smallest height 201).

At step 210, the sequence 200 includes determining a row-grouping threshold 211A-C based on the grouping threshold candidates 207, 209. In some embodiments, the row-grouping threshold 211A-C is referred to as a “vertical position threshold.” The analysis service 109 can determine the row-grouping threshold 211A-C by determining the minimum of the grouping threshold candidates 207, 209. For example, the analysis service 109 computes a first grouping threshold candidate 207 of about 19.66 points and a second grouping threshold candidate 209 of about 29 points. In the same example, the analysis service 109 determines that the first grouping threshold candidate 207 is less than the second grouping threshold candidate 209 and, in response, determines the row-grouping threshold 211A-C to be about 19.66 points.

At step 212, the sequence 200 includes grouping the text portions 203A-F into rows based on the row-grouping threshold 211A-C. The analysis service 109 can perform row grouping by centering the row-grouping threshold 211A about vertical midpoints of the leftmost text portions of a text section or image (e.g., or rightmost, top, or bottom text portions depending on the alphabet or language of the text portions). For example, the analysis service 109 centers the row-grouping threshold 211B about a vertical midpoint 215A of the text portion 203A and centers the row-grouping threshold 211C about a vertical midpoint 215D of the text portion 203D. The analysis service 109 can extend the vertical midpoints 215A, 215B rightward and can group text portions into rows by determining text portions that overlap the vertical midpoint 215A or 215B. In another approach, the analysis service 109 can determine a set of coordinates (e.g., Y-axis values) that bound the row-grouping threshold 215A-C about the vertical midpoint of the corresponding leftmost text portion. In this approach, the analysis service 109 can perform grouping by determining text portions with boundary coordinates that fall within the determined set of threshold coordinates and assigning those text portions to the same row.

FIG. 3 shows an exemplary handwriting analysis process 300. As will be understood by one having ordinary skill in the art, the steps and processes shown in FIG. 3 (and those of all other flowcharts and sequence diagrams shown and described herein) may operate concurrently and continuously, can be asynchronous and independent, and are not necessarily performed in the order shown. According to one embodiment, by the process 300, the system 100 generates one or more entries derived from handwritten content (e.g., or other content including text) and performs one or more actions based on the one or more entries, such as, for example, generating a subscriber list 121 and initiating a targeted campaign.

At step 303, the process 300 includes receiving an image, such as, for example, a digital photograph. The image can include text, such as, for example, one or more handwritten entries to a sign-up sheet. The image can include printed text, such as, for example, printed column and row titles. In some embodiments, the image includes only handwritten text. Non-limiting examples of images include, but are not limited to, sign-up sheets, attendance forms, interest forms, and contact lists. Receiving the image can include receiving, via a network, an image from a computing device. For example, a computing device can retrieve a stored camera image of a sign-up sheet and transmit the camera image to the computing environment. Receiving the image can include capturing the image. For example, a computing device can capture an image of an attendance sheet and transmit the image to the computing environment. In some embodiments, the computing environment receives a plurality of images. In at least one embodiment, the computing environment receives multiple images of the same document (e.g., to ensure at least one image demonstrates sufficient quality or to allow for generation of a composite image). In some embodiments, the computing environment receives a plurality of images in which each image demonstrates a variation, such as, for example, a variation in angle, lighting, or contrast.

The computing environment 101 can receive the image from a particular user account, or from a computing device 105 with which the particular user account is associated. The computing environment 101 can receive the image via a particular network address with which the particular user account is associated. In one example, a computing device 105 captures an image of a sign-up sheet and the capture application 131 transmits the image to the communication service 110. In this example, installation of the capture application 131 on the computing device can include generating and registering a user account with the computing environment 101 such that, upon receiving the image transmission, the computing environment 101 automatically associates the image with the user account.

In some embodiments, the capture application 131 and/or the communication service 110 provides a template (e.g., for a sign-up sheet or other suitable framework for receiving handwritten data) that may be printed and filled out by various individuals. The template can include an identifier (e.g., a barcode, QR code, numerical identifier, etc.) that, when detected by the capture application 131 or the communication service 110, causes the system 100 to uniquely associate entries to the template with a particular user account or computing device 105. The template can include predefined structures for organizing data, such as, for example, lines that define rows and columns and fields that may include header information for indicating data type. In some embodiments, the capture application 131 and/or the communication service 110 can receive input from a current user of predefined or custom columns or fields to include in the template. The template can include predetermined text that instructs a subject to fill out the template according to one or more rules (e.g., legible print, no cursive, staying inside of lines, etc.). The capture system 129 can capture one or more images of the template and the communication service 110 can receive the one or more images via the capture application 131 (e.g., or another service running on the computing device 105).

At step 306, the process 300 includes generating one or more text portions and position data based on the image. A text portion can include metadata that defines a position of the text portion within the image and handwritten data that defines one or more handwritten characters. The communication service 110 can store the metadata as position data 113. The position metadata can include, for example, coordinate sets that define each text portion. In at least one embodiment, the position metadata defines text sections in the image. For example, the position metadata defines a first table and a second table included in the image, and each table includes a plurality of text portions that be analyzed with respect to text portions in the same table. The OCR service 107 can generate the text portions and the position metadata by performing one or more optical character recognition techniques on the image and, thereby, generating OCR data that defines the positions of handwritten and printed characters in the image. The computing environment 101 can call the OCR service 107 and transmit the image to the OCR service 107 for OCR processing. In response to the call, the OCR service 107 can process the image and return the text portions and position metadata to the computing environment 101. The position data can define boundaries of handwritten and typed characters. The position data can define boxes (e.g., or other shapes) that encapsulate one or more characters and, thereby, define the text portions. The OCR process can refer to any suitable OCR process, including but not limited to computer vision processes and machine learning processes. Performing optical character recognition can include generating a call to a library or a service. The call can cause the library or service perform optical character recognition on the image. The library or the service can be a local library or a local service, such as, for example, a library or a service hosted at the computing environment or the computing device from which the image was received. The library or the service can include a third-party library or a third-party service associated with an external system with which the computing environment communications. In some embodiments, the call to the library or the service includes the image (e.g., or data associated therewith, such as a cropped, aligned, or otherwise transformed version of the image). In some embodiments, the OCR service 107 detects handwriting symbols and shorthand that may affect text portion generation and analysis. For example, the OCR process may detect that particular text in an image include a strike-through, thereby indicating that the text should be disregarded. In this example, the OCR service 107 excludes the text from text portions based on the strike-through. In some embodiments, the communication service 110 (e.g., and/or the analysis service 109) performs handwriting symbol and shorthand detection to flag detected symbols or shorthand prior to transmitting the OCR service 107.

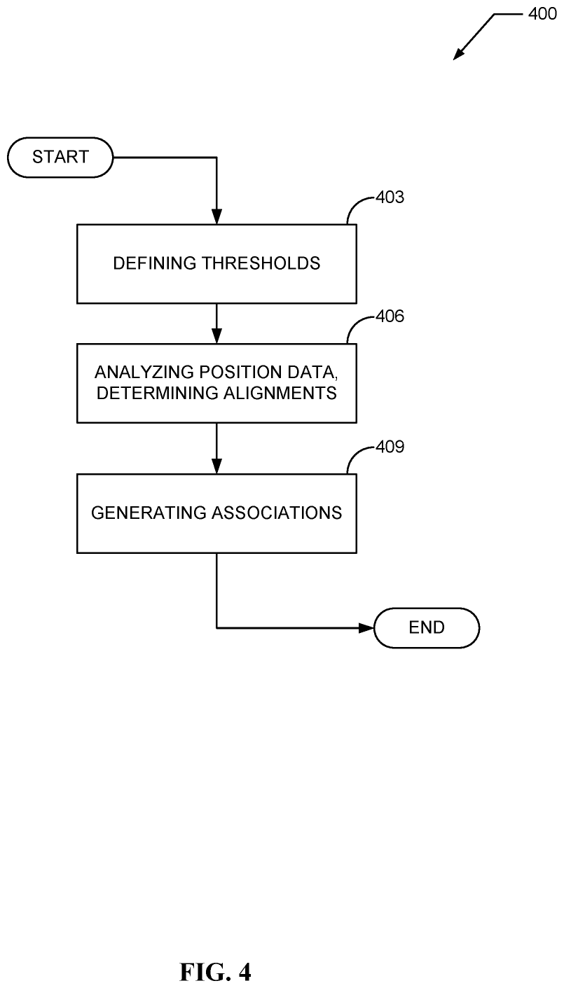

In at least one embodiment, the process 300 includes performing an association generation process 400 (FIG. 4) to generate and define associations between the text portions of step 306 (e.g., or other text portions). By the association generation process 400, the system 100 can generate column associations and row associations that group each text portion with a row and a column. In various embodiments, the system 100 performs the association generation process 400 following step 306.

At step 309, the process 300 includes analyzing the text portions and associating each text portion with one or more data types based on the analysis. For example, the analysis service 109 performs a spelling analysis to detect typos and other spelling errors in the text portions. In another example, the analysis service 109 performs a punctuation error analysis to detect punctuation deficiencies in the text portions. The computing environment can analyze the text portions to determine if one or more spelling errors are present. For example, the computing environment performs a word recognition process to match each word of each word portion to a predetermined word from a language corpus. In this example, if the word recognition fails to match a text portion (e.g., or a subset thereof) to a predetermined word, the computing environment determines that the text portion includes a spelling error.

The analysis service 109 can perform one or more analyses to determine a particular type of data with which each text portion (e.g., or a subset thereof) are associated. For example, the analysis service 109 analyses a text portion that includes handwritten data “John Allan Smith,” and the analysis service 109 determines that “John Allan Smith” corresponds to a full name data type. In the same example, the analysis service 109 can determine that “John” corresponds to a first name data type, “Smith” corresponds to a last name data type, and “Allan” corresponds to a middle name data type. The analysis service 109 can compare and match text portion content to datasets of labeled terms (e.g., first name datasets, last name datasets, etc.) to classify the data type of the text portion. The analysis service 109 can use one or more machine learning models to predict a data type with which the text portion is associated. For example, the analysis service 109 can execute a random forest classification model on the text portion to classify the text portion into one of a plurality of data types including, but not limited to, names, dates, addresses, phone numbers, emails, usernames, dates and times, and selections (e.g., selections for a particular category, such as t-shirt sizes, or option, such as a preferred contact method).

The analysis service 109 can iterate through each row and/or column and generate a data type association for each text portion therein. In some embodiments, the analysis service 109 uses a data type association of a previous column portion as a factor for determining a data type association of a subsequent column portion within the same column. For example, a determination that a text portion of a previous column portion is associated with a last name data type causes the analysis service 109 to increase a likelihood that a text portion of a subsequent column portion is also associated with the last name data type. The analysis service 109 can determine a data type for a column by ranking the frequency of data types demonstrated in column entries and determining a data type of the column as the highest ranked data type (e.g., which may also be compared to a predetermined minimum threshold). In other words, the analysis service 109 can determine a data type of a column as the data type demonstrated by a majority or a top-ranked plurality of the elements of the column. For example, the analysis service 109 determines that 66% (e.g., or any suitable threshold, such as 40%, 50%, 85%, or 95%) of the entries in a column are of a “first name” data type and, in response, the analysis service 109 assigns the column to the “first name” data type. In one embodiment, the analysis service 109 can determine a data type for a column based on making a determination that image corresponds to a predetermined or previously generated template provided by the system 100. For example, a user may generate a signup sheet from a template including a first name field, and the analysis service 109 can identify the template from the image (e.g., using an embedded identifier or by analyzing or comparing the image to the previously generated templates) and map the data types of the columns from the template to the columns in image.

The analysis service 109 can perform a data type association analysis by applying one or more rules to each text portion (e.g., or to subsets thereof, or to a row or column with which the text portion is associated). For example, the analysis service 109 can apply a rule such that, if a text portion contains an “@” character and/or an email platform extension (e.g., “gmail,” “hotmail,” etc.), the analysis service 109 classifies the text portion as an “email” data type. Non-limiting examples of rules include rules for physical addresses, first names, last names, middle names, phone numbers, employment position, relation (e.g., mother, father, etc.), public identifier (e.g., such as an employee ID number), currency, sizing (e.g., sizing of clothing apparel), and preferred contact method.

The analysis service 109 can determine a data type of a column and associate the data type with each text portion that is associated with the column. In some embodiments, after determining column or row data type association, the analysis service 109 analyzes each text portion associated with the column or row to determine if the same data type association applies. The analysis service 109 can determine that a text portion is associated with a particular data type (e.g., first name, last name, etc.) by analyzing the header of the column with which the text portion is associated. For example, to determine if a text portion includes a first name, the analysis service 109 applies a case-insensitive localized search to the header with which the text portion is associated. In this example, the analysis service 109 can search the header for terms “first,” “name,” “first name,” “firstname,” and other suitable terms that may be predictive for indicating that terms in the corresponding column are first names. The analysis service 109 can exclude columns (e.g., and text portions therein) from data type analyses by applying one or more rules to the columns. For example, the analysis service 109 can apply a rule such that columns including email address-associated characters (e.g., “@,” “.com,” and other extensions) or other contact-associated characters (e.g., numbers, location-related terms, etc.) are excluded from analyses for detecting first name and last name data types.

The analysis service 109 can perform multiple techniques individually or in combination to determine a particular data type associated with a text portion, such as a first name. The analysis service 109 can perform an initial localized search of a column header, determine that the header includes “name,” and determine that a text portion associated with the column is likely to include a name. To further determine if the text portion includes a first name, the analysis service 109 can determine that the text portion includes characters that correspond to a first name character set (e.g., letters A-Z, or non-phonetic alphabet equivalent, accent marks, diacritical marks, spaces, dashes, and periods). The analysis service 109 may also determine that the text portion excludes characters that correspond to a character set of another data type (for example, an email character set that includes an “@” character or a phone number character set that includes numerical characters).

The analysis service 109 can search a first name database (e.g., or other appropriate database of another data type, depending on header classification or other factors) based on the text portion and determine that the text portion matches an entry in the first name database. The analysis service 109 can perform matching by executing case insensitive, anchored, literal string comparisons against the first name database (e.g., or other suitable data type database, such as a last name database, address database, etc.). An “anchored search” can refer to a search that is initiated from the beginning of a text portion and, thus, excludes entries that contain the text portion but do not initiate with the text portion. For example, the analysis service 109 determines a match between text portion “Maria” and database entry “Maria,” but determines a mismatch between text portion “Maria” and database entry “BBBMaria.” When searching the first name database the analysis service 109 can apply one or more rules, such as, for example, rejecting any single character name candidates (e.g., “A,” “U,” “X,” etc.) and trimming the text portion to eliminate white space or new lines (e.g., “Michael” becomes “Michael”). The analysis service 109 can apply a rule by splitting the text portion into sub-components and searching the first name database for entries that match one or more of the sub-components. For example, the analysis service 109 splits the text portion “Maria Gabriella” into two sub-components based on whitespace between the two terms. In the same example, the analysis service 109 searches the first name database for entries that match either “Maria” or “Gabriella.” Based on determining one or more database matches, the analysis service 109 can determine that the text portion is associated with the corresponding data type.

The analysis service 109 can perform data type association by converting a text portion string into a vector representation and computing a similarity metric between the text portion vector representation and a plurality of data type vector spaces (e.g., the closer a text portion vector is to a particular data type vector space, the more likely the text portion is associated with the corresponding data type). The similarity metric can include, for example, a squared Euclidean distance, an L2 norm metric, a cosine similarity metric, or any suitable measure of probability that the text portion vector and a particular subspace are mated or non-mated. The analysis service 109 can generate each data type vector space by converting a plurality of text entries (e.g., with known, shared data type associations) to vector representations and by defining the data type vector space based on the vector representations. For example, the analysis service 109 converts a plurality of first names to a plurality of first name vectors to define a first name data type vector space, converts a plurality of addresses to a plurality of address vectors to define an address data type vector space, and converts a plurality of contact information strings (e.g., phone numbers, emails, etc.) to contact information vectors to define a contact information vector space.

At step 312, the process 300 includes applying one or more corrections to the text portions or metadata related to the same, such as, for example, row associations, column associations, or data type associations. In one example, the analysis service 109 determines that a text portion is associated with an email data type and that the text portion includes a misspelling of an email domain name (e.g., the text portion reads “JohnSmith@gmall.com” instead of “JohnSmith@gmail.com). Continuing the example, the analysis service 109 modifies the text portion to include the correct spelling of the email domain name. The analysis service 109 can apply corrections based on correction data received from one or more computing devices (e.g., at step 321 of the process 300). In another example, the communication service 110 receives correction data from a capture application 131 (e.g., the correction data being generated based on a user's manual corrections) and causes the analysis service 109 to correct a corresponding text portion based on the correction data. In another example, the analysis service 109 compares the text portions to historical correction data 119 and identifies one or more correction trends, instances, or patterns between the historical correction data 119 and the current text portions being analyzed. Continuing the example, the analysis service 109 applies one or more corrections to the text portions based on the historical correction data 119.

The analysis service 109 can apply a correction by changing a row, column, and/or data type association of one or more text portions. In some embodiments, when the analysis service 109 corrects a row or column association of a text portion, the analysis service 109 automatically reassigns a data type association of the text portion based on the new row or column association. In some embodiments, the analysis service 109 reanalyzes the text portion to determine if the data type association of the text portion should be adjusted. For example, following a correction that includes reassigning a text portion from a first column to a second column, the analysis service 109 automatically performs one or more actions of step 309 to reevaluate the data type of the text portion.

The analysis service 109 can apply a correction by identifying a local region, determining a local regional rule associated with the local region, and apply the local regional rule to one or more text portions. In some embodiments, the local region refers to the location of the computing device 105 from which the input of step 303 was received. In at least one embodiment, the local region refers to a location associated with a user account corresponding to a user of the computing device 105 (e.g., or of the user with which the capture application 131 is registered). In one example, the analysis service 109 determines that an input image is associated with St. Louis, Mo. and determines a local regional rule including local and national telephone number extensions (e.g., “314” prefix for St. Louis, Mo., and a “+1” prefix for the United States). Continuing the example, the analysis service 109 applies corrections to text portions classified as phone number data type by appending the “314 “and “+1” prefixes to each text portion.

The analysis service 109 can determine a pattern or trend in historical correction data 119 and/or in correction data 119 obtained from a user, and the analysis service 109 can generate and implement automated pre-processing operations to correct the error addresses by the correction pattern or trend. The analysis service 109 can determine that a particular type of correction or correction pattern was performed in excess of a predetermined threshold. The analysis service 109 can generate a new pre-processing rule based on the threshold-exceeding correction such that the correction is performed automatically in subsequent iterations of the process 300 (e.g., or in other processes of the system 100).

At step 315, the process 300 includes generating one or more entries based on the text portions and metadata. The communication service 110 can generate the entries by creating a data object including a plurality of fields that are each associated with a particular type of data. For example, the communication service 110 generates a table in which fields are arranged into rows and columns. In this example, each row can correspond to an individual or other entity associated with a particular set of text portions (e.g., a first row represents all text portions associated with a first individual, a second row represents all text portions with a second individual, and etc.). In the same example, each column can correspond to a particular type of data (e.g., a first column represents a first name data type, a second column represents a last name data type, a third column represents an email address data type, and etc.). The communication service 110 can assign each field to an individual or column based on association data 115 generated by the analysis service 109 for each text portion. The communication service 110 can store the fields (e.g., or the data object containing the same) at the data store 111 and/or at the computing device 105. The communication service 110 can generate a respective entry to a subscriber list 121 for each row of text portions and the communication service 110 can store the text portions in fields that correspond to the type of data with which each text portion is associated.

At step 318, the process 300 includes performing one or more appropriate actions related to the entries of step 315. In some embodiments, the computing environment 101 stores each text entry in the data store 111 or another data storage location, such as a separate remote database or cloud storage environment. The communication service 110 and/or the capture application 131 can generate and cause the rendering of user interfaces for presenting the text entries to a user and for receiving corrections to the text entries from the user. The communication service 110 can generate and transmit an electronic communication that includes the text portion entries (e.g., or a data object containing the same, such as a table or chart). For example, the communication service 110 transmits the text portion entries to the capture application 131 and the capture application 131 causes the corresponding computing device 105 to present the text portion entries to a user for review and editing. The communication service 110 can transmit the electronic communication in the form of electronic mail, an SMS or other text message, an alert, a push notification, or any other suitable communication format. The communication service 110 or the capture application 131 can generate a contact or other user profile for each text portion entry. In one example, the text portion entries describe a plurality of individuals that signed up for a particular activity or entity. In the same example, the communication service 110 transmits the text portion entries to the capture application 131 and the capture application 131 generates and stores a contact for each individual in memory of the corresponding computing device 105. In another example, the communication service 110 generates a subscriber list 121 that defines a plurality of individuals based on the text portion entries.

In some embodiments, the communication service 110 automatically transmits, or schedules transmission of, a communication to each individual represented by the text portion entries. In one example, the communication service 110 automatically transmits an invitation message, confirmation message, or other predetermined communication to each email address included in the text portion entries. In another example, the communication service 110 automatically initiates a machine learning process to generate targeted communications for each individual represented in the text portion entries (e.g., the targeted communications being associated with a targeted campaign, such as a new user program, customer retention initiative, or promotional sales offer).

In at least one embodiment, the communication service 110 transmits a communication indicating that one or more text portions could not be processed and including one or more reasons why processing could not be performed (e.g., insufficient image quality, insufficient handwriting quality, no match to any predetermined data type, etc.). In one example, following a determination that an input image is of insufficient clarity and is misaligned, the communication service 1110 transmits a communication to the capture application 131 that causes the computing device 105 to render an error screen on the display thereof. In this example, the error screen can include instructions for improving the brightness of the image and a virtual frame for properly aligning the corresponding image subject (e.g., a sign-up sheet or other document) to obtain an input image of sufficient quality.

In at least one embodiment, the computing environment 101 computes and reports one or more confidence levels that estimate the overall estimated accuracy of the process 300 in analyzing the input image or that estimate the accuracy of the association for each text entry (e.g., or for a set of text entries associated with the same row or column). The analysis service 109 can leverage multiple factors for determining confidence level including, but not limited to, an OCR confidence level, the presence or absence of headers for indicating particular data types, the percentage of text portions in a column that match an overall data type association of the column, and the level of pre-processing and/or correction applied to the input image (e.g., or to a text portion derived therefrom). The communication service 110 can generate a communication or user interface for presenting the one or more confidence levels. The communication or user interface can include a visual indicator scheme for communicating the confidence level of the overall output, of each text entry column, of each individual text entry. For example, the visual indicator scheme can include red, yellow, and green colorations for indicating increasing levels of confidence. In one example, the analysis service 109 determines that a column of text portions is associated with a first name data type and determines that 70% of the text portions in the column are associated with the first name data type. Continuing the example, the communication service 110 assigns the column a yellow coloration to indicate a middle confidence level in the data type association of the column.

At step 321, the process 300 includes receiving correction data 119. The computing environment 101 can receive user input defining one or more corrections to the text entries. For example, the capture application 131 receives user input that changes a data type association of a text entry from “first name” to “middle name” or from “street address” to “last name.” In the same example, the capture application 131 provides the user input to communication service 110 as correction data 119. In another example, the computing environment 101 receives correction data 119 that changes a row association of a text entry from a first row to a second row (e.g., or that changes a column association of the text entry from a first column to a second column).

FIG. 4 shows an exemplary association generation process 400 according to various embodiments of the present disclosure. At step 403, the process 400 includes defining one or more thresholds including, but not limited to, a row-grouping threshold (also referred to as a vertical position threshold) or a column-grouping threshold (also referred to as a horizontal position threshold). The analysis service 109 can determine the vertical position threshold based on the handwriting classification sequence 200 (FIG. 2).

In an exemplary scenario, the computing environment 101 receives an input image of a document and generates position data 113 including a plurality of text portions and metadata defining the position of the same within the document. The analysis service 109 determines (e.g., via the sequence 200 of FIG. 2) a vertical position threshold based on position data 113 of a first text portion of the plurality of text portions (for example, a left, uppermost text portion). The vertical position threshold can be a minimum between half the average vertical height of the plurality of text portions and an overall minimum text portion vertical height less one. The analysis service 109 can determine a horizontal position threshold by determining the minimum between half the average horizontal width of the plurality of text portions and an overall minimum text portion width less one. In at least one embodiment, the horizontal position threshold is a minimum amount of white space that may be used to determine boundaries between text portions and, thereby, identify distinct columns. In some embodiments, the OCR service 107 determines one or more horizontal position thresholds or, otherwise, defines a plurality of columns and determines column associations for each text portion.

In some embodiments, the system 100 performs a first iteration of the process 400 to generate row associations for each text portion and performs a second iteration of the process 400 to generate column associations for each text portion (e.g., the second iteration leveraging the row associations of the first iteration to achieve column association assignment).

At step 406, the process 400 includes analyzing position data of the text portions in relation to the one or more thresholds of step 403 and identifying row and column alignments for the text portions based on the analysis. In some embodiments, the analysis service 109 performs step 406 of the process 400 according to step 212 of the sequence 200 (FIG. 2).

In an exemplary scenario, the analysis service 109 determines a vertical midpoint for each of a plurality of text portions and compares each respective vertical midpoint to the vertical position threshold. The analysis service 109 identifies a subset of the plurality of text portions with a respective vertical midpoint within the vertical position thresholds. The analysis service 109 determines the first text portion and the subset are aligned within a row.

In some embodiments, following determination that a first text portion and a second text portion are aligned in the same row, the analysis service 109 repeats step 403 to recalibrate the current vertical position threshold or determine a new vertical position threshold based on position data 113 associated with the first and second text portions. The recalibration of the vertical position threshold may allow the analysis service 109 to determine row alignments with increased precision and accuracy.

The analysis service 109 can apply one or more algorithms, machine learning models, or other techniques to determine column and row alignment. The analysis service 109 (and/or the OCR service 107) can apply a Hough line transform to the input image to detect lines in the input image that may indicate locations of columns and rows. From the Hough line transform, the analysis service 109 can generate position data 113 including a plurality of lines that may represent columns and rows in the input image. The position data 113 can include coordinates that define each row and column. The analysis service 109 can determine column and row alignment by determining text portions with coordinates that fall within the coordinates of a respective row and column.

At step 409, the process 400 includes generating associations for each text portion including but not limited to row associations and column associations. The analysis service 109 can generate a row or column association for a text portion by defining the association in metadata with which the text portion is associated. In one example, for each text portion determined to be aligned in a row or a column, the analysis service 109 generates text portion metadata (e.g., position data 113 or analysis data 117) that assigns the text portion to the row or column. Continuing the example, the text portion metadata allows the analysis service 109 to evaluate column-mated text portions for purposes of associating the text portions (e.g., or the respective column) with a particular type of data. In the same example, the text portion metadata allows the communication service 110 to accurately group and arrange entries derived from the text portions according to row and column associations.

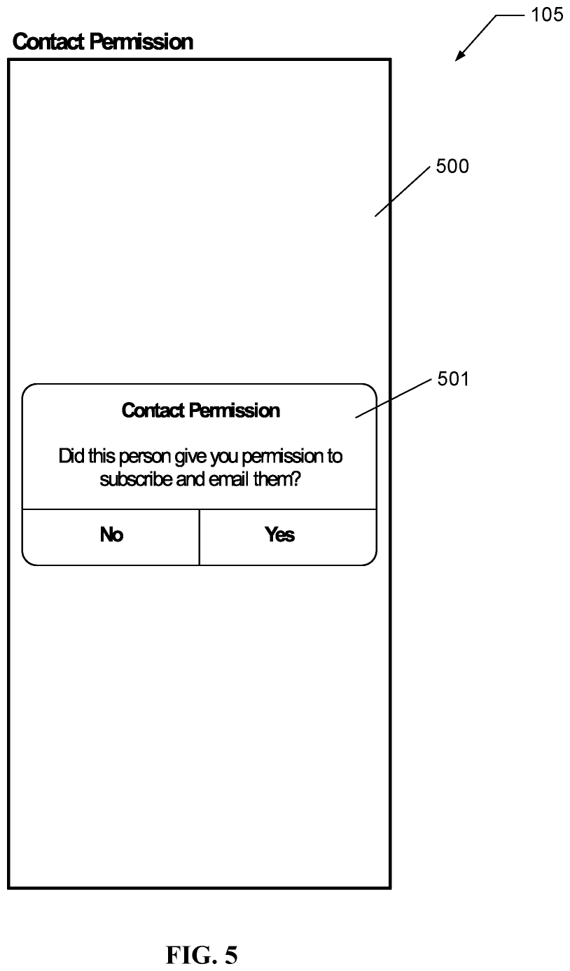

FIGS. 5-14 show exemplary user interfaces that may be rendered on the display 125 of the computing device 105 (e.g., in response to user input and/or commands from the capture application 131 or computing environment 101).

FIG. 5 shows an exemplary user interface 500 that may be rendered on a computing device 105. The user interface 500 can include a field 501 for receiving input from a user. Before initiating a targeted campaign or otherwise transmitting communications to entries of a subscriber list 121, the system 100 can require a user to confirm the field 501 for indicating that the individuals to be contacted have consented to receiving communication from the user. The computing environment 101 can update the subscriber lists 121 of the data store to indicate entries for which communication consent has been confirmed.

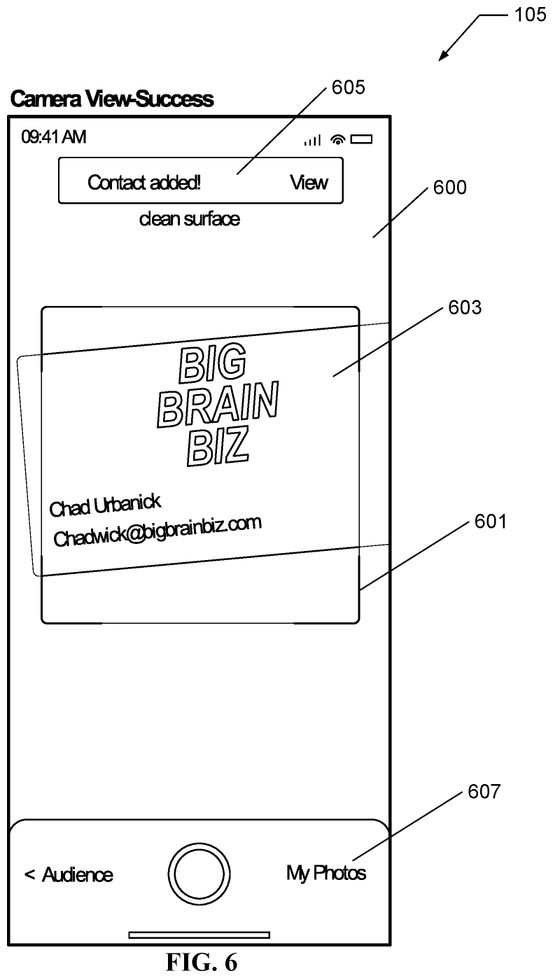

FIG. 6 shows an exemplary user interface 600 that may be rendered on a computing device 105. The capture application 131 can cause the computing device 105 to render a frame 601 for properly aligning a text source 603 for an image capture by the capture system 129. The text source 603 can include any physical object (for example, business cards, sign-up sheets, forms, etc.) or any digital visualization (for example, an image on a screen). The capture system 129 can capture an image of the text source 603 and the system 100 can generate OCR data and text data based on the image. The system 100 can generate text portions and data type associations thereof and can generate a contact entry based thereon. The capture application 131 can receive and store the contact entry at the computing device 105. The capture application 131 can cause the computing device 105 to render a visual indicator 605 for alerting the user to actions performed based on the text source 603. For example, the visual indicator 605 can include text that indicates a contact has been generated and stored based on the text source 603.

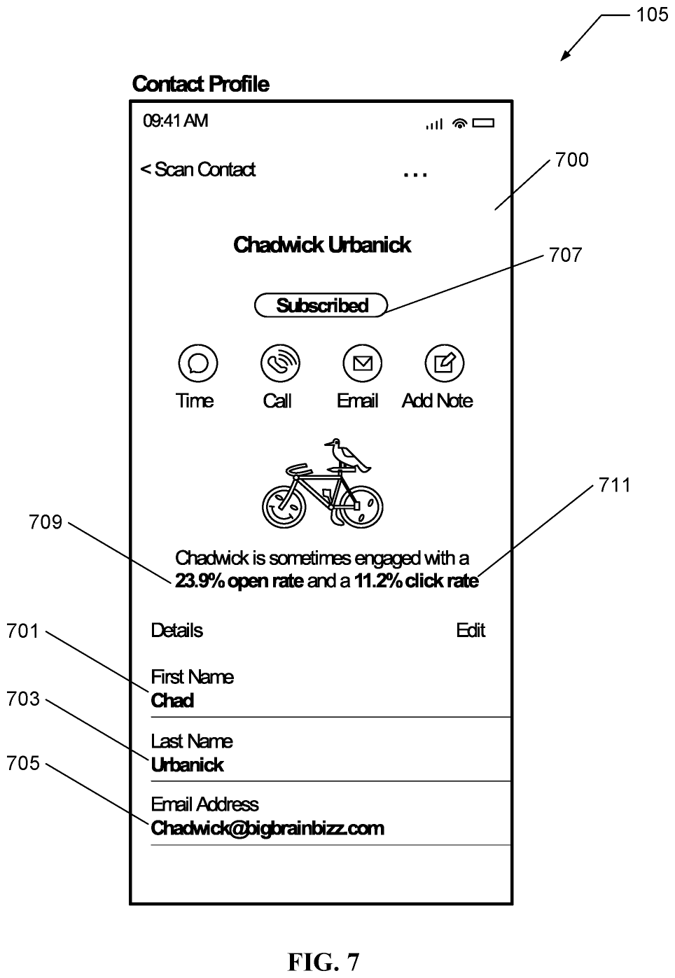

FIG. 7 shows an exemplary user interface 700 that may be rendered on a computing device 105. The capture application 131 can generate text fields 701, 703, 705 based on a subscriber list 121 or other text recognition output generated by the system 100. The fields 701, 703, 705 can present recognized text data and types thereof to the user for review. The capture application 131 can render a status indicator 707 for indicating whether an individual defined in the fields 701, 703, 705 is subscribed to communications (e.g., targeted campaigns, mailers, etc.) from the user. The capture application 131 can render communication metrics 709, 711 for indicating historical results of attempts to communicate with the individual. For example, the communication metric 709 indicates a historical open rate that measures a percentage of historical communications accessed by the individual. In another example, the communication metric 711 indicates a historical click rate that measures a percentage of historical communications with which the individual interacted.

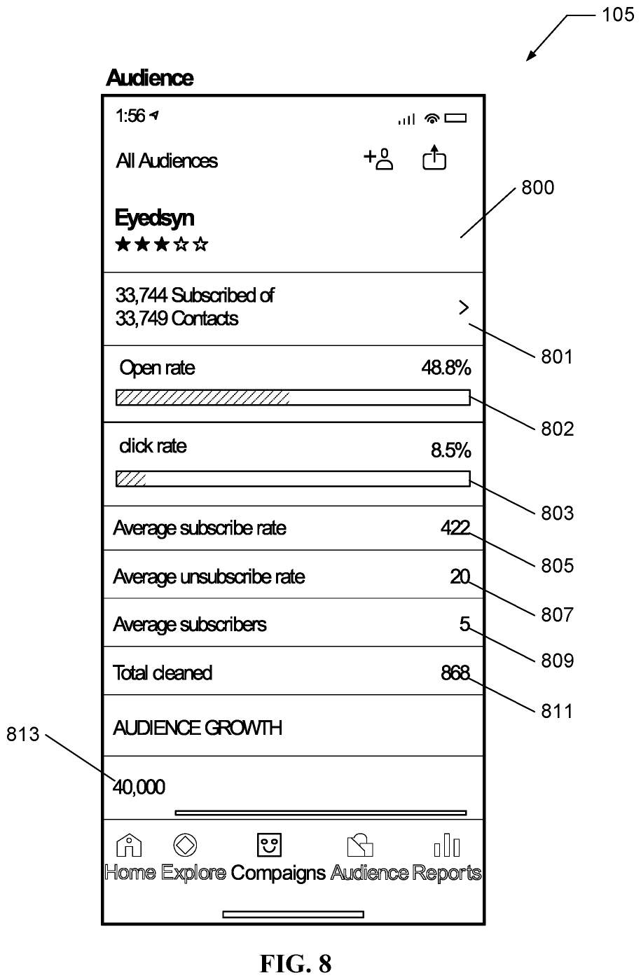

FIG. 8 shows an exemplary user interface 800 that may be rendered on a computing device 105. The user interface 800 includes additional exemplary communication metrics 801, 802, 803, 805, 807, 809, 811, 813 that may be presented to a user for purposes of presenting targeted campaign (e.g., or other communication) data. The communication metrics 801-813 can indicate a relation of subscribers to contacts, historical open rates, click rates, average (un)subscription rates, average subscribers, total entries cleaned/corrected (e.g., quantity of each type of correction made, total corrections made, quantity of corrections rejected and accepted during human review), total audience growth, and other suitable measures of communication performance or effect.

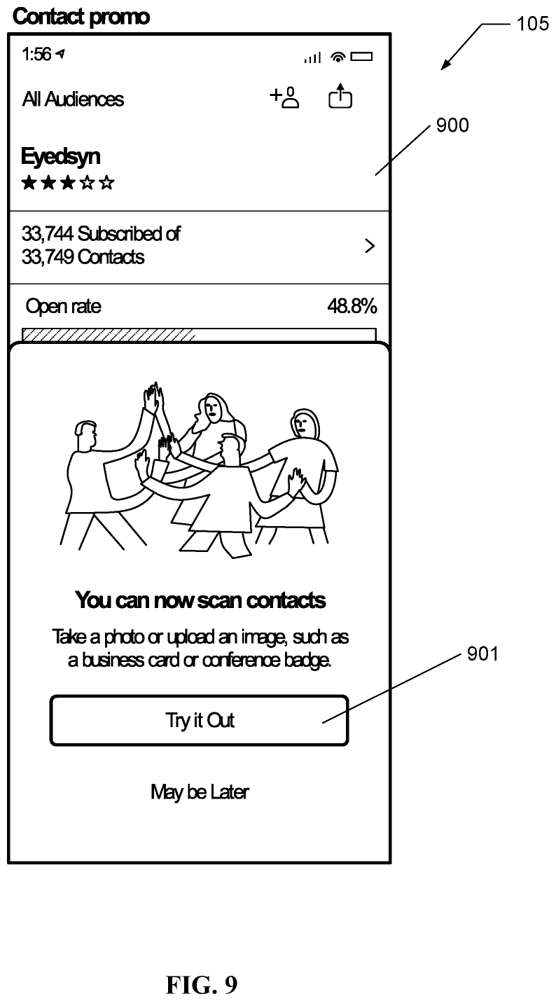

FIG. 9 shows an exemplary user interface 900 that may be rendered on a computing device 105. The capture application 131 can automatically or in response to user input (for example, selection of an “add contact” field) render a field 901 for initiating various text recognition functions and processes described herein. In response to selection of the field 901, the capture application 131 can activate the capture system 129 for purposes of capturing an image to be processed by the system 100.

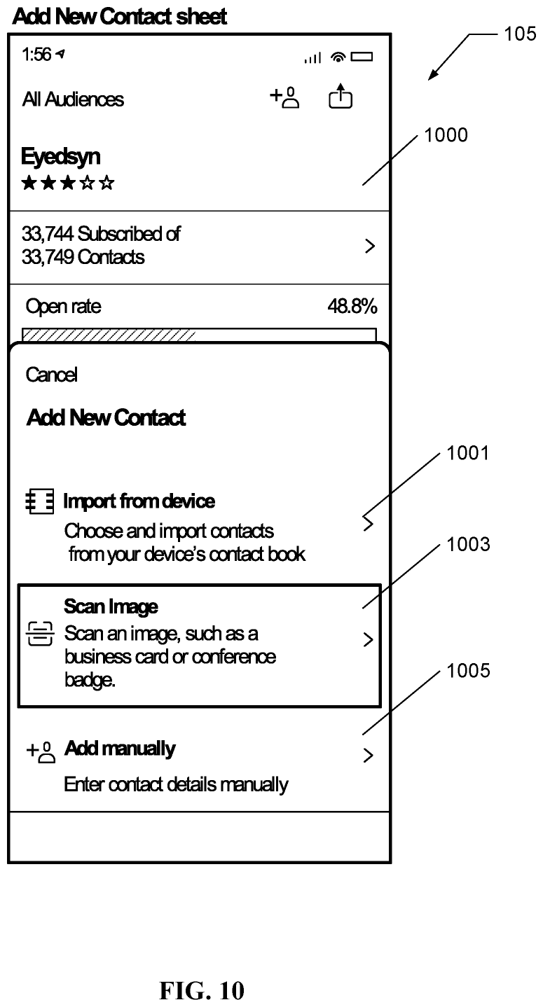

FIG. 10 shows an exemplary user interface 1000 that may be rendered on a computing device 105. The capture application can present a user with a plurality of selectable options 1001, 1003, 1005 for adding and storing contact information. For example, the selectable options 1001-1005 can include a first option for importing contacts from another storage location on or accessible to the computing device 105, a second option for recognizing text in an image and generating a contact based thereon, and a third option for manual entry of contact information.

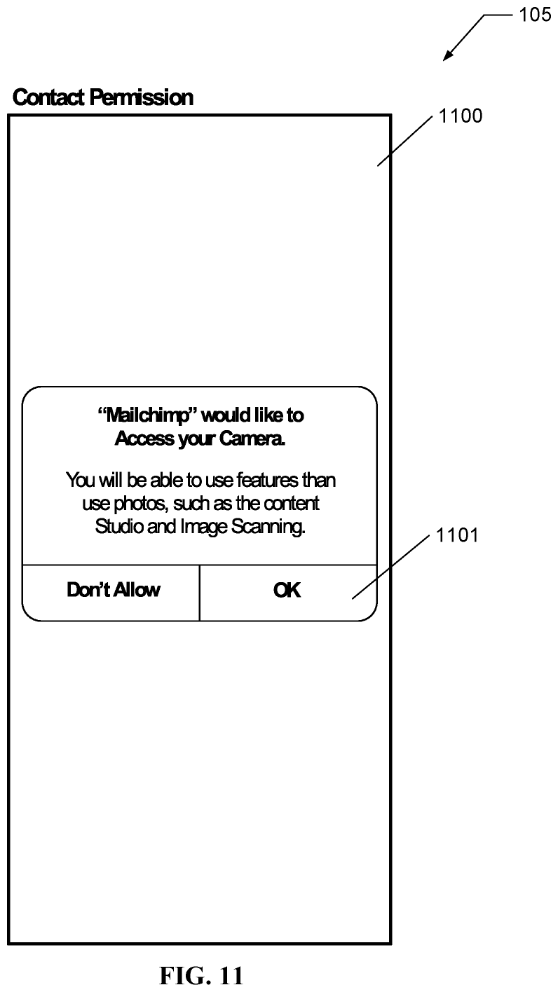

FIG. 11 shows an exemplary user interface 1100 that may be rendered on a computing device 105. The capture application 131 can render an approval field 1101 for receiving permission from a user to activate the capture system 129.

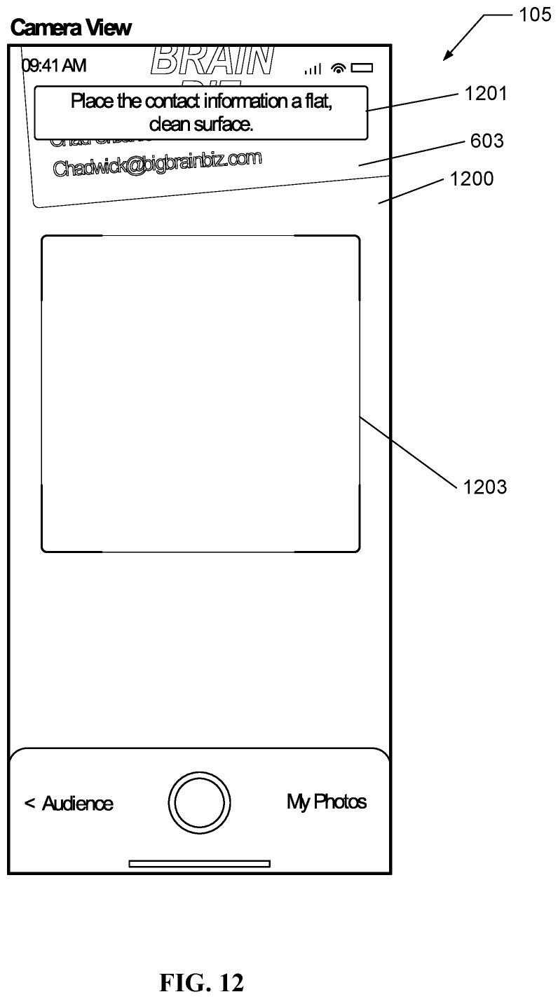

FIG. 12 shows an exemplary user interface 1200 that may be rendered on a computing device 105. The capture application 131 can render an instruction visual 1201 that instructs the user to orient a text source 603 within a rendered frame 1203 for capture by the capture system 129. The capture application 131 can perform active image recognition and processing to determine if the text source 603 is fully, or otherwise sufficiently, aligned within the frame 1203.

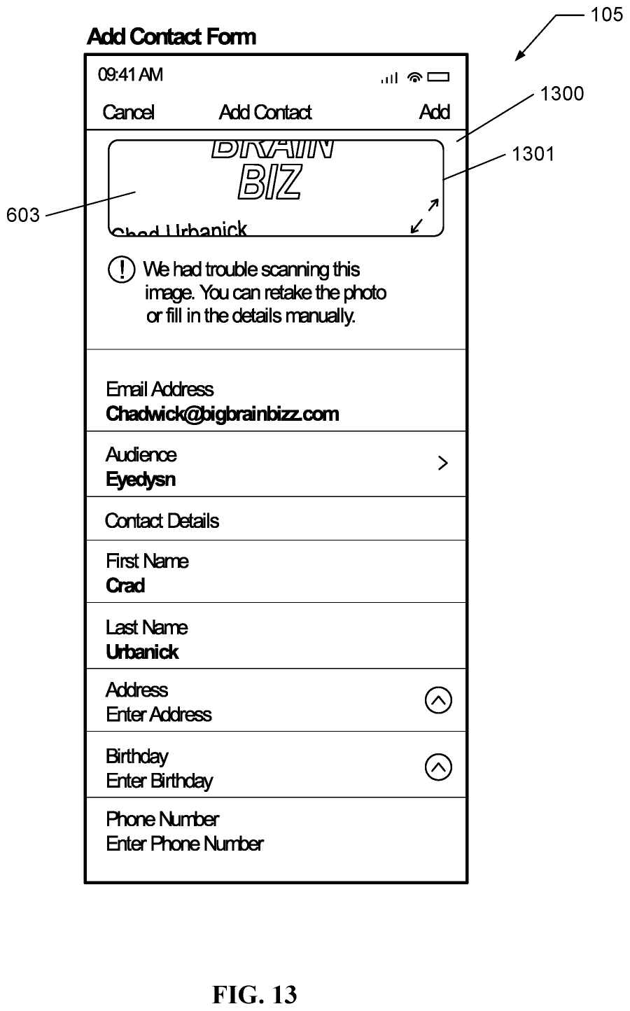

FIG. 13 shows an exemplary user interface 1300 that may be rendered on a computing device 105. The capture application 131 can render an alert frame 1301 that informs the user of insufficient image alignment and/or quality. The capture application 131 can allow the user to capture additional images of the text source 603 or enter the related data manually.

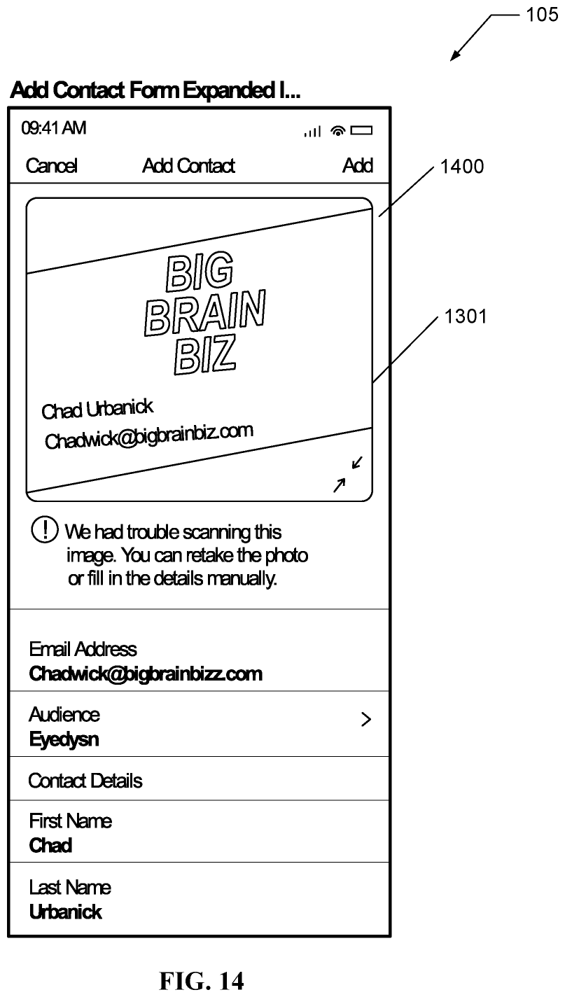

FIG. 14 shows an exemplary user interface 1400 that may be rendered on a computing device 105.

From the foregoing, it will be understood that various aspects of the processes described herein are software processes that execute on computer systems that form parts of the system. Accordingly, it will be understood that various embodiments of the system described herein can be implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Program modules can include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A method, comprising:
capturing, via at least one computing device, an image comprising at least one handwritten portion;
performing, via the at least one computing device, optical character recognition to the at least one handwritten portion to generate a plurality of text portions, wherein each of the plurality of text portions comprise respective position data;
associating, via the at least one computing device, each of the plurality of text portions with a respective row of a plurality of rows based on the respective position data;
associating, via the at least one computing device, each of the plurality of text portions with a respective column of a plurality of columns based on the respective position data;
analyzing, via the at least one computing device, individual ones of the plurality of text portions associated with a particular column of the plurality of columns to determine a particular type of data corresponding to the particular column; and
generating, via the at least one computing device, an entry in a data store for each of the plurality of rows with the individual ones of the plurality of text portions from the particular column being stored in a field associated with the particular type of data.

2. The method of claim 1, further comprising analyzing, via the at least one computing device, second individual ones of the plurality of text portions associated with a second particular column of the plurality of columns to determine a second particular type of data corresponding to the second particular column, wherein the entry comprises the second individual ones of the plurality of text portions from the second particular column being stored in a second field associated with the second particular type of data.

3. The method of claim 1, further comprising analyzing, via the at least one computing device, the individual ones of the plurality of text portions associated with the particular column to identify at least one text correction based on the particular type of data.

4. The method of claim 3, wherein the particular type of data comprises an email address and the method further comprising correcting, via the at least one computing device, the at least one text correction by:
identifying at least one character in the email address that does not fit a format of email addresses; and
changing the at least one character in the email address to fit the format of email addresses.

5. The method of claim 1, wherein the particular type of data comprises one of a name, an email address, an address, a company, and a title.

6. A system, comprising:
a data store comprising a subscriber list; and
at least one computing device in communication with the data store, the at least one computing device configured to:
perform optical character recognition of an image to identify a plurality of text portions, wherein each of the plurality of text portions comprise respective position data and a subset of the plurality of text portions comprise handwritten data;
associate each of the plurality of text portions with a respective row of a plurality of rows based on the respective position data;
associate each of the plurality of text portions with a respective column of a plurality of columns based on the respective position data;
analyze individual ones of the plurality of text portions associated with a particular column of the plurality of columns to determine a particular type of data corresponding to the particular column; and
generate a respective entry to the subscriber list for individual ones of a subset of the plurality of rows with the individual ones of the plurality of text portions from the particular column being stored in a field associated with the particular type of data.

7. The system of claim 6, wherein the at least one computing device is further configured to analyzing the plurality of text portions to determine if a subset of the plurality of text portions correspond to a respective header of the plurality of columns.

8. The system of claim 7, wherein determining the particular type of data is based on the respective header for the particular column.

9. The system of claim 6, wherein the at least one computing device is further configured to:
generate a targeted campaign for a user account associated with the subscriber list; and
transmit the targeted campaign to each of a plurality of entries in the subscriber list, the plurality of entries comprising the respective entry for the individual ones of the subset of the plurality of rows.

10. The system of claim 6, wherein performing the optical character recognition on the image to identify the plurality of text portions comprises generating a call of at least one of: a library or a service to perform the optical character recognition on the image and receiving the plurality of text portions in response to the call.

11. The system of claim 6, wherein associating each of the plurality of text portions with the respective row based on the respective position data comprises the at least one computing device being further configured to:
determine vertical position thresholds for a row of the plurality of rows based on the respective position data of a first text portion of the plurality of text portions;
determine a respective vertical midpoint associated with individual ones of the plurality of text portions based on the respective position data;
identify a subset of the plurality of text portions with a respective vertical midpoint within the vertical position thresholds; and
assign the first text portion and the subset of the plurality of text portions to the row.

12. The system of claim 6, wherein associating each of the plurality of text portions with the respective row based on the respective position data comprises the at least one computing device being further configured to:
determine vertical position thresholds for a row of the plurality of rows based on the respective position data of a first text portion of the plurality of text portions;
determine a second text portion of the plurality of text portions meets the vertical position thresholds based on the respective position data of the second text portion; and
determine updated vertical position thresholds for the row based on the respective position data for both of the first text portion and the second text portion.

13. The system of claim 12, wherein the at least one computing device is further configured to:
iterative through a remaining subset of the plurality of text portions to:
determine a current iteration text portion of the plurality of text portions meets the updated vertical position thresholds based on the respective position data of the current iteration text portion;
assign the current iteration text portion to a set of text portions in the row, the set of text portions comprising the first text portion and the second text portion; and
update the updated vertical position thresholds for the row further based on the respective position data for the current iteration text portion.

14. A system, comprising:
a memory; and
at least one computing device in communication with the memory, the at least one computing device configured to:
identify a plurality of text portions in an image, wherein each of the plurality of text portions comprise respective position data and a subset of the plurality of text portions comprise handwritten data;
associate each of the plurality of text portions with a respective row of a plurality of rows based on the respective position data;
associate each of the plurality of text portions with a respective column of a plurality of columns based on the respective position data;
analyze individual ones of the plurality of text portions associated with a particular column of the plurality of columns to determine a particular type of data corresponding to the particular column; and
generate a correction to at least one of the plurality of text portions associated with the particular column based on the particular type of data.

15. The system of claim 14, wherein the at least one computing device is further configured to generate a respective entry to a subscriber list for individual ones of a subset of the plurality of rows with the individual ones of the plurality of text portions from the particular column being stored in a field associated with the particular type of data.

16. The system of claim 14, wherein the at least one computing device is further configured to:
identify a local region associated with a user account corresponding to a current user; and
identify at least one regional rule corresponding to the local region, wherein the correction to the at least one of the plurality of text portions is generated by applying the at least one regional rule.

17. The system of claim 14, wherein the at least one computing device is further configured to:
render a user interface comprising the plurality of text portions arranged in the plurality of rows and the plurality of columns; and
receive at least one additional correction from a user via the user interface to at least one of the plurality of text portions.

18. The system of claim 17, wherein the at least one computing device is further configured to:
determine the correction to the at least one of the plurality of text portions by applying a machine learning model to each of the plurality of text portions; and
train of the machine learning model based on the at least one additional correction from the user.

19. The system of claim 14, wherein the at least one computing device is further configured to preprocess the plurality of text portions to identify at least one additional correction prior to generating the correction.

20. The system of claim 19, wherein the at least one additional correction comprises at least one of: a spelling error, a formatting error, or a punctuation error.
